(19) United States
(12) Patent Application Publication
(10) Pub. No.: US 2012/0277003 A1
(43) Pub. Date: Nov. 1, 2012

(54) PLATFORM-INDEPENDENT INTERNATIONAL GAMING FRAMEWORK

(76) Inventors: Nichola Eliovits, San Jose, CA (US); Peter Ajlouny, San Jose, CA (US)

(21) Appl. No.: 13/459,257

(22) Filed: Apr. 30, 2012

Related U.S. Application Data
(60) Provisional application No. 61/480,299, filed on Apr. 28, 2011.

(51) Int. Cl. A63F 13/12

(52) U.S. Cl. 463/42

(57) ABSTRACT

A system for providing a platform-independent international gaming framework and a cross-language communication tool includes a localization module to localize a game experience within a multiplayer game environment, a communication module to translate communications of the plurality of users into a language associated with a client device and/or social network settings, and an interface for the platform-independent international gaming framework. The localization may be based on geographical locations, default language of the client device and/or social network profile, demographics, and personal information of the users. The localization may also include automatically loading one or more specific elements based on the localization criteria. In some example embodiments, the user may be enabled to create a virtual gaming venue based on predetermined criteria, which may be localized by the gaming framework based on user-related information and information associated with the location of the user.

### CROSS-REFERENCE TO RELATED APPLICATIONS

This application claims the benefit under 35 U.S.C. §119(e) of U.S. Provisional Patent Application No. 61/480,299, entitled “Platform-Independent International Gaming Framework and a Cross-Language Communication Tool,” filed on Apr. 28, 2011, which is incorporated herein by reference in its entirety.

### FIELD

This application relates to data processing and, more specifically, to a platform-independent framework for playing games online across multiple languages.

### BACKGROUND

Online multiplayer games have become a very popular pastime as they can be played over a computer network. The expansion of online gaming has reflected the overall expansion of computer networks from small local networks to worldwide networks such as the Internet. Online games can range from simple text based games to games of cards incorporating complex graphics and virtual worlds populated by many players simultaneously. Many online games have associated online communities, making online games a form of social activity beyond single player games. However, because of cultural and language differences, these online game communities are typically limited to a specific geographical region or to speakers of a specific language.

Online multiplayer games may feature virtual currency to play games and purchase virtual goods and services within online communities or online games. The virtual goods may include, for example, digital gifts and digital clothing for avatars. Virtual goods may be sold by companies that operate social networks, community sites, or online games. These goods typically reflect values of the game creators and do not take into account cultural diversity of players despite the fact that players may hail from any geographical region or culture.

Additionally, a multiplayer online game may feature a chat functionality such as direct one-on-one chat or text-based group chat. Being able to communicate with other players may be highly important for the overall experience of the game. However, the chat functionality may be meaningless to players who speak different languages.

### SUMMARY

This summary is provided to introduce a selection of concepts in a simplified form. These concepts are further described below within the detailed description. This summary is not intended to identify key or essential features, nor is it intended to be used as an aid in determining the scope of the claimed subject matter.

In an example, a method for providing a platform-independent international gaming framework, also referred to herein as the gaming framework, is provided. The method provides for localizing a game experience of a plurality of international users based on predetermined localization criteria associated with the users and translating communications between the users. The predetermined localization criteria may include a geographical location, various demographics, personal information, a client device default language, and a social network profile default language. Thus, for different players playing the same game, a look and feel of the gaming framework and the virtual goods presented may vary depending on the above parameters.

The localization may include automatically loading one or more specific elements of a multiplayer game based on the predetermined localization criteria. The method may further enable the users to change the default language associated with the multiplayer game. The translation of communications may occur within a chat box associated with the game interface. The translation may be performed automatically or when the user clicks on the text to be translated. The source language of the translation may be indicated. The client device may be run on various platforms such as Windows, UNIX, Mac OS, iOS, Android OS, Windows Phone, Symbian OS, Windows Mobile, Palm webOS, bada, MeeGo, Maemo, Limo, Brew OS, and so forth.

In some example embodiments, it may be possible for the user to create a virtual gaming venue or game based on predetermined criteria. The virtual gaming venue that has been created may be automatically localized by the gaming framework based on user-related information and information associated with the location of the user.

In some example embodiments, it may be possible for the user to create a game or gaming venue based on information associated with other users or a location of the other users.

In further examples, steps of the above method may be stored on a machine-readable medium comprising instructions, which when implemented by one or more processors, perform the method. In examples, subsystems or devices can be adapted to perform the above method. Other features, examples, and embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which a platform-independent international gaming framework and a cross-language communication tool can be implemented, in accordance with an example embodiment.

FIG. 2 is a block diagram illustrating components of the platform- independent international gaming framework, in accordance with an example embodiment.

FIG. 3 is a process flow diagram illustrating a method for platform-independent international gaming and a cross-language communication tool, in accordance with an example embodiment.

FIGS. 4-6 illustrate pages of an online game which can be played by a plurality of users within the platform-independent international gaming framework, in accordance with an example embodiment.

FIGS. 7-13 illustrate settings of an online game which can be played by a plurality of users within the platform-independent international gaming framework, in accordance with an example embodiment.

FIG. 14 is a process flow diagram illustrating interactions between a social network and a platform-independent international gaming framework, in accordance with an example embodiment.

FIG. 15 is a block diagram, providing an overview of functionality provided by the Lobby and Game pages of the platform-independent international gaming framework, in accordance with an example embodiment.

FIG. 16 discloses interactions between the Lobby Overview page and other parts of the platform-independent international gaming framework, in accordance with one embodiment.

FIG. 17 is a diagrammatic representation of an example machine in the form of a computer system within which a set of instructions, for causing the machine to perform any one or more of the methodologies discussed herein, are executed.

### DETAILED DESCRIPTION

In some example embodiments, systems and methods for creating a platform-independent international gaming framework and a cross-language communication tool are described.

The following detailed description includes references to the accompanying drawings, which form a part of the detailed description. The drawings show illustrations, in accordance with example embodiments. These example embodiments, which are also referred to herein as “examples,” are described in enough detail to enable those skilled in the art to practice the present subject matter. The embodiments can be combined, other embodiments can be utilized, and structural and/or logical changes can be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

A cross-platform international gaming framework is provided. The framework may allow users to play multiplayer games across the Internet via a mobile device, specific site (e.g., Popover), or a social networking site (e.g., Facebook). Players may use client devices running on different platforms (e.g., iOS, Android, and Windows Phone).

In some example embodiments, users may play against one another and have a customized (unique/localized) gaming experience based on location, device/profile default settings, and other predetermined criteria. Based on the above predetermined criteria, players may see different/localized versions of the same game. Specifically, the language of the game may be set to the default language of a connecting platform or social network profiles of the users, or be reset to a language that the users choose. The framework may automatically mirror the game based on the language reading right to left or left to right.

In some example embodiments, the virtual goods displayed to a user may be tailored to the user based on the user age, language, location, and/or other predetermined criteria. For example, a user in New York might see a virtual good such as a Pizza, while another user in Israel might see a Falafel. Similarly, a 21 year-old Arabic player from Bahrain may see a Silver Sports Car that resembles the car of the King, while a 65 year-old person from the US who speaks English may see a NYT or Newsweek periodical. Based on where the user is logged in from, or other differentiating details that have been obtained, the platform can be adjusted to automatically load varying elements when the user connects to the cross-platform international gaming framework.

Furthermore, the cross-platform international gaming framework may feature a chat box functionality, which may incorporate real-time chat translation and allow each of the users who are logged in to type and receive responses in a native language. For example, the user playing an online game of cards may type in the chat box in French (or any other supported language), but be seated at a table with users from Russia, Spain, and so forth. Each user may see messages coming from the other users auto-translated or translated when clicked on by the user into the native language of the user. If the messages are automatically translated, the messages may be marked to identify the original language that the messages were composed in and inform the user who receives the messages that the text has been translated. A user may also be provided with the ability to toggle the auto-translate feature on and off. If the messages are not automatically translated, a message can appear instructing user on how to obtain the translation.

In some example embodiments, especially when the user invites users from other geographies to play a variation of a game local to the geography in which the user is located, the user may be able to send to other users a link to a page that provides rules for the game variation in question. In the same or other embodiments, this may be done in advance (for example, when a game is scheduled by the user). The rules may then be translated into a language associated with a location of the users.

In some example embodiments, whenever the user is invited to play a variation of the game that is not recognized by the system as being characteristic of the geography or location of the user, the system may display a prompt or otherwise offer the user a chance to get familiar with corresponding rule differences.

In some example embodiments, the gaming framework may include a dynamic map to display regional variations of the game selected by the user in relation to respective geographies. In the same or other example embodiments, the afore-mentioned map may also list a language (possibly in parenthesis next to the name of a game variation) most of the players of this variation of the game are likely to speak.

In some example embodiments, when the user hovers a cursor over a location in the above-mentioned dynamic map, the map may display the games and regional game variations characteristic of the location in response. The information that is displayed may include information on customized/localized/specifically styled gaming venues available in the system and related to the selected geography.

In some example embodiments, one or more audios characteristic of a gaming venue selected by the user may be set to play in the background as the game starts. In the same or other embodiments, the user may be able to select from multiple audio options and compile play lists. A special capability enabling the user to request the approval of the play list by other players may be incorporated.

In some example embodiments, the system may include a search capability that allows searching for other players of the game variation. For example, the user may be enabled to locate those players of the game variation that have indicated game variation-related preferences in user profiles of the players in the system. It may also be possible to search for users associated with a specific location or search for users speaking the specific language.

In some example embodiments, the gaming framework may include a custom social network.

In some example embodiments, the gaming framework may include an email system.

In some example embodiments, the gaming framework may include a rating system. The rating system may be able to calculate ratings for the one or more gaming venues. The rating system may also be able to rate all the players of the game variations or gaming venues. The said information may be rendered available to the user. In the same or other embodiments, the user may be able to rate the game variations, gaming venues, and/or games.

In different example embodiments, the rating system of the gaming framework may be able to rate the games, game variations, gaming venues, and more based both on user ratings and on statistical information amassed by the gaming framework.

In some example embodiments, the user may be able to recommend the game, gaming venue, or game variation to one or more other users. This recommendation may be performed by sending a link to the game, game variation, or gaming venue to email accounts of the one or more other users, or by sending the link to the game, game variation, or gaming venue through the internal mailing system of the gaming framework.

In some example embodiments, the gaming framework may include a game-scheduling capability (for example, a game-scheduling capability that is based on a subscribable game, game variation, or gaming venue-specific calendar). For instance, if the user wants to play a game of poker at an Australian venue, the user may locate the venue using the search functionality of the gaming framework, and schedule a game session. It may be possible to indicate a variety of parameters for a game session that has been scheduled, including the name of the game, name of the game variation, name of the gaming venue, language of the game session, name of the user who scheduled the game session, and so forth. The one or more other users of the gaming framework may subscribe to a scheduled game session and the user who scheduled the game session may be notified that one or more other users of the gaming framework have subscribed to the game session. Notifications indicating the current number of subscribed users may also be sent to the one or more other users who have subscribed to the game session. The user who has scheduled the game session and the one or more other users of the gaming framework who have subscribed to the game session may be able to share the subscribable calendars with the one or more other users of the gaming framework. For example, it may be possible to display the subscribable calendars that have been shared on the user profile page in the internal social network of the system or on the user profile page in the one or more other social networks.

Furthermore, it may be possible for the user who scheduled the game session to cancel the game session and send corresponding notifications to the one or more other users who have subscribed to the game session. In the same or other embodiments, the one or more other users may cancel a subscription to the game session and send the corresponding notifications to the user who scheduled the game session.

In some example embodiments, the system may support creating custom recurrent or reproducible game sessions. Such game sessions may be associated with/based on a specific gaming venue. The user may be able to store a past game session, including the names of the users who have taken part in the game session, and schedule it to be reproduced on a specific future date. In this case, the system may automatically notify the one or more users who took part in the past game session about the game session having been rescheduled for a future date. In further embodiments, it may be possible to set the game session to be automatically rescheduled and reproduced recurrently at specified intervals. In some example embodiments, the gaming framework may provide an interface that enables viewing and managing stored game sessions of the user. The user may be allowed to modify a game session that has been stored.

It may also be possible for the user to share the stored game session with the one or more other users via email or the internal mailing system.

In some example embodiments, membership-based club-type gaming venues may be supported, wherein a membership may need to be approved by a specifically designated user with administrative privileges (venue administrator). The membership in the above venues may be paid.

In some example embodiments, the user may be able to create custom gaming venues based on prefabricated templates and/or multiple criteria. For example, it may be possible to select a poker template, a geography and/or location, the language the game session will be held in, an audio background, and so forth. Furthermore, the system may be able to automatically choose or adjust the look and feel of a newly created gaming venue, and/or select appropriate virtual goods for the gaming venue based on the user- or user location-related information, or based on the location of the gaming venue selected. In the same or further embodiments, creating the custom gaming venue may be a paid service.

In some example embodiments, the gaming framework may be able to rank local game variations based on a number of users from other geographies/locations who have chosen to play the above game variations. For example, the local game variation may be ranked based on a number of users from other geographies who have chosen to repeatedly play this game variation.

In some example embodiments, the game or gaming venue may be created by the user based on the user- or user location-related information of other users who are invited by the user for a game of cards. For example, if the user is interested in playing with some specific players, the user may custom-create the game based on information associated with the above users and the locations/geographies of the above users, schedule the game, and send invitations.

In some example embodiments, commercialization opportunities may include sharing a part of the proceeds associated with paid memberships in closed club-type or custom venues between a gaming framework owner and venue administrator.

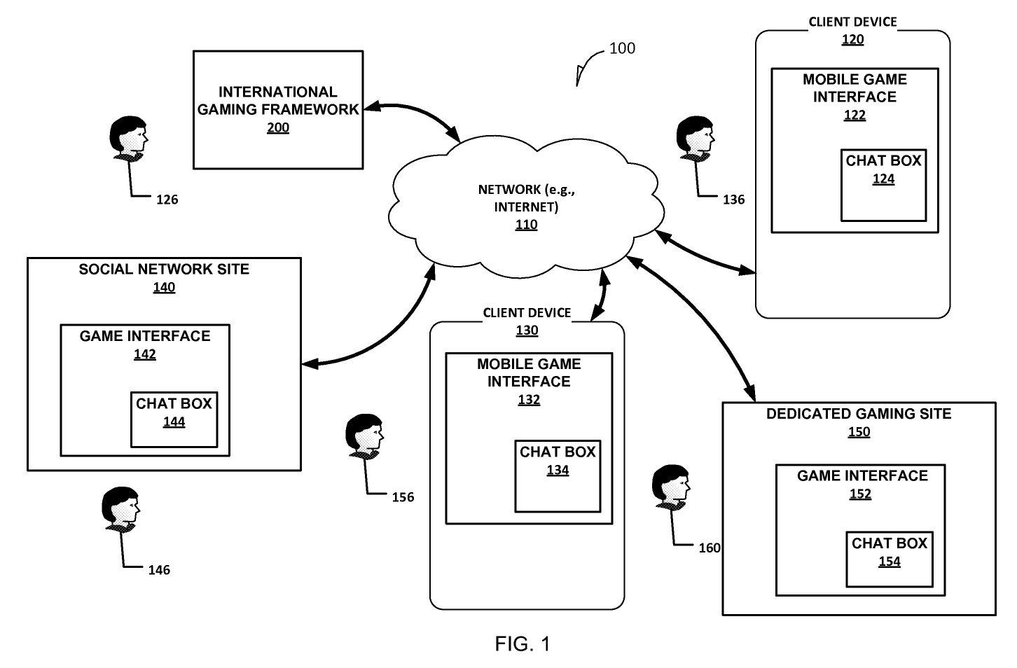

Referring now to the drawings, FIG. 1 is a block diagram showing a network environment 100 within which a platform-independent international gaming framework and a cross-language communication tool may be implemented, in accordance with one example embodiment. As shown in FIG. 1, the example network environment 100 may include a network (e.g., the Internet) 110, client devices 120 and 130, a social network site 140 (e.g., Facebook), a dedicated gaming site 150, and users 126, 136, 146, 156, and 160. The network 110, as shown in FIG. 1, is a network of data processing nodes interconnected for the purpose of data communication, which may be utilized to communicatively couple various components of the network environment 100. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-202 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The client devices 120 and 130 may include mobile game interfaces 122, 132 and the chat boxes 124, 134, respectively. The social network site 140 and the dedicated gaming site 150 may include game interfaces 142, 152 and the chat boxes 144, 154, respectively. The international gaming framework 200 may enable users 126, 136, to play games across the client devices 120, 130, the social network site 140, and the dedicated gaming site 150 (which may run on various operating systems such as Mac OS, Windows, Android, iOS, Windows Phone, and so forth) against one another. The information displayed to the users 126, 136 may be in localized mirror languages of respective users so that each of the users 126, 136 playing from a different locale may see different content. For example, the user 126 in the Philippines playing on an iPad may see virtual goods in a virtual store that are either unique or in a unique order. In some embodiments, however, despite the order being unique, the list of the goods users see may remain the same across different countries. The international gaming framework 200 may serve as a backbone interconnecting different platforms, social networks, the Internet, mobile devices (running operating systems such as Android or iOS), and providing one gaming framework for a game by connecting to the same place but showing unique content and virtual goods based on the specificity of the device, or based on other settings associated with each particular user 126.

In some example embodiments, the game may be localized based on a virtual gaming venue that has been selected.

In some example embodiments, particularly when the game is localized based on the virtual gaming venue that has been selected and the users 126, 136 taking part in the game are from the same or closely situated locations, the contents and look and feel of the game displayed to the users 126, 136 may be the same or very similar.

In some example embodiments, depending on the geography or location that the users 126, 136 are logged in from, the users 126, 136 may be invited to select from several regional varieties of the game that are characteristic of their geography or location. The localization may be combined with the translation of communications between various users 126, 136 whose default of selected language differs.

Thus, for example, if an Arabic speaker types a message in Arabic for somebody who is an English-speaking user, the English-speaking user may see a translation of the original message. In some example embodiments, depending on the geography or location of the users 126, 136, the system may display the local name of the game that has been selected, if any. This may be especially useful if the users 126, 136 are about to play a game with users 126, 136 from other geographies and speaking other languages or regional variations of the same language.

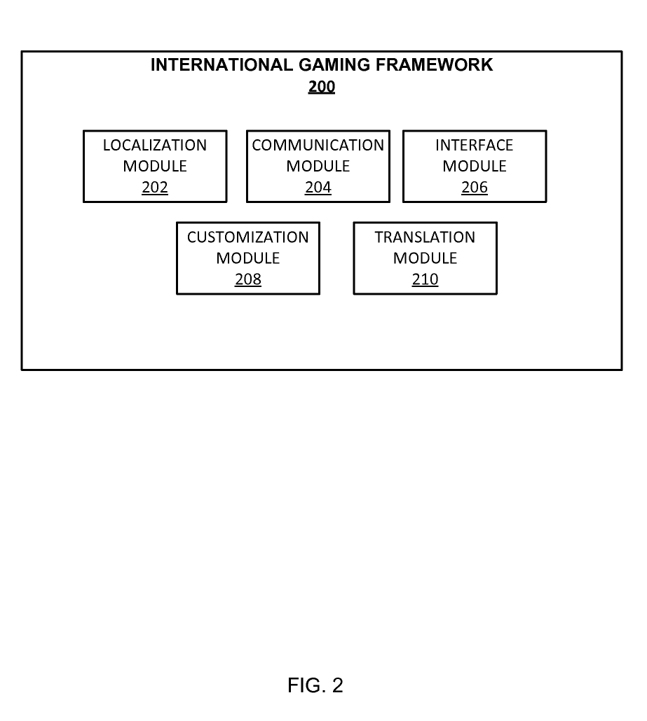

The users 126, 136 may be able to download a game from an application store such as, for example, the Apple or Android App Store. Similarly, to play the game, the user 126 may go to a social network website (e.g., Facebook), which will connect to the international gaming framework 200. The language can be selected from the device or default language of the social network user. Virtual goods that are sold within the game environment may be specifically localized. For example, the user 136 playing the game on Facebook may buy the virtual goods from a gift shop, which has a varying inventory of the virtual goods depending on the location and language of the user 136. The international gaming framework 200 is described in more detail below with reference to FIG. 2.

FIG. 2 is a block diagram showing the international gaming framework 200, in accordance with an example embodiment. As shown in FIG. 2, the international gaming framework 200 may include a localization module 202, a communication module 204, an interface module 206, a customization module 208, and a translation module 210. The localization module 202 may localize, based on predetermined criteria associated with the users 126, 136, a game experience of the respective users within the network environment 100. The communication module 204 may translate (either automatically or when clicked on the text by the user) communications of the users 126, 136 into respective languages of the users. The localization may be based on the geographical locations of the client devices, demographics and personal information of the users 126, 136, and a language associated with the client devices 120 and 130 or the social network site 140. The localization may include automatically loading one or more specific elements based on the localization criteria. The customization module 208 may enable the users 126, 136 to change respective default languages of the users. The interface module 206 may be provided as part of the games associated with the platform-independent international gaming framework 200. The translation module 210 may translate messages communicated via the chat boxes 124, 134, 144, and 154 by the users 126, 136. The users 126, 136 may be able to toggle on and off the automatic translation. The source language of the translation may be indicated.

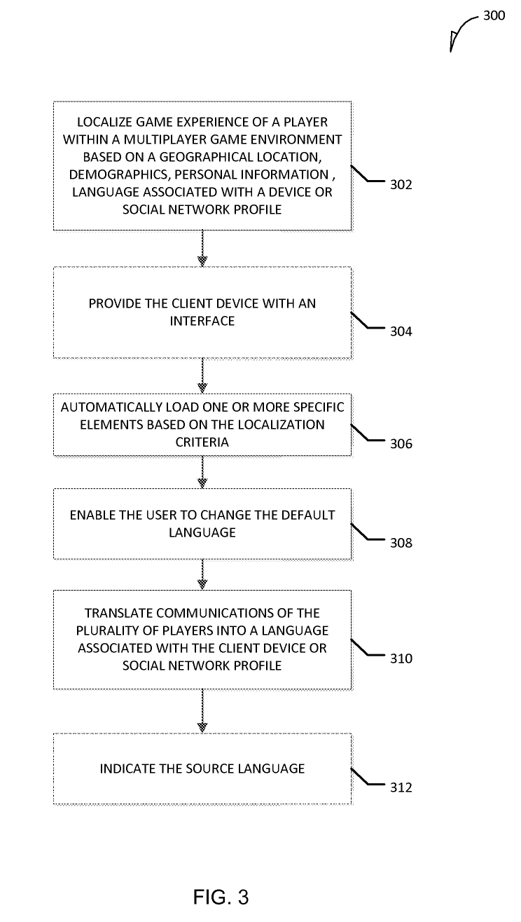

FIG. 3 is a process flow diagram illustrating a method 300 for platform-independent international gaming and a cross-language communication tool, in accordance with one example embodiment. The method 300 may be performed by processing logic that may comprise hardware (e.g., dedicated logic, programmable logic, microcode, etc.), software (such as is run on a general-purpose computer system or a dedicated machine), or a combination of both. In one example embodiment, the processing logic resides at the international gaming framework 200 illustrated in FIG. 2. The method 300 may be performed by the various modules discussed above with reference to FIG. 2. Each of these modules may comprise processing logic.

The method 300 may commence at operation 302 with the localization module 202 localizing a game experience of the player within a multiplayer game environment based on the geographical location, demographics, personal information, the language being associated with a device, or a social network profile. At operation 304, the interface module 206 may provide the client device with an interface. At operation 306, the localization module 202 may automatically load one or more specific elements based on the localization criteria. At operation 308, the customization module 208 may enable the users 126, 136 to change the default language, and at operation 310 the translation module may translate communications of the plurality of players into the language associated with the client device or social network profile. Optionally, at operation 312, the source language may be indicated to the users 126, 136. In some example embodiments, the translation of the communications between the users 126, 136 may be performed automatically in real time, while in other example embodiments the users 126, 136 may have to highlight the text that needs to be translated and click on a button (for example, a Translate button).

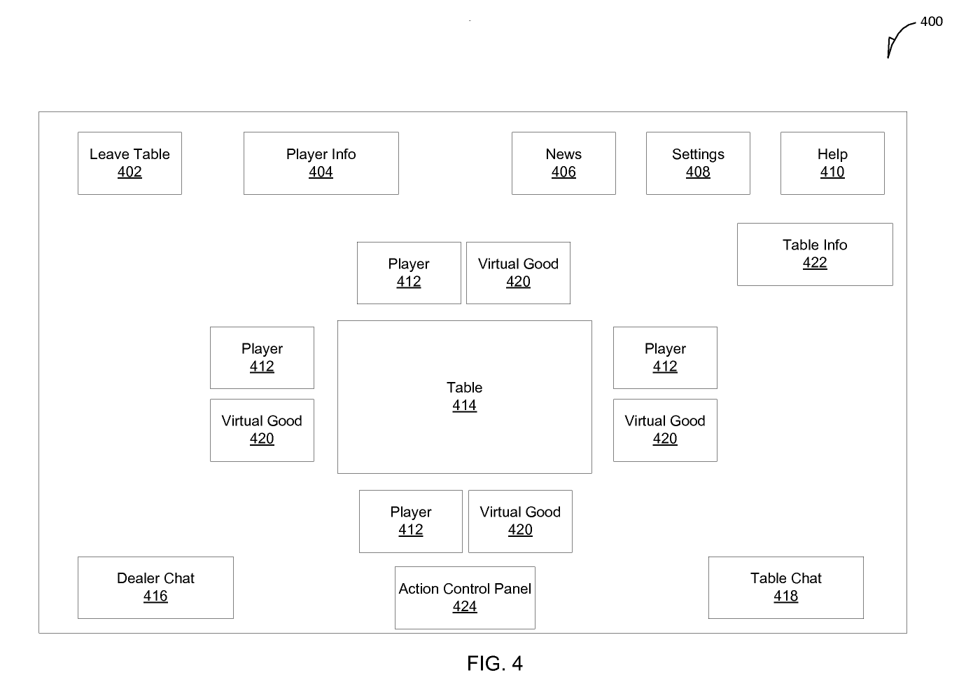

FIG. 4 illustrates a table 414 on a Game page 400 where a game of cards is being played, in accordance with one example embodiment. The players 412 may be located around the table 414, and the amount of virtual currency that the players 412 have indicated may be located next to the players 412. Virtual goods 420 that have been purchased by the players 412 may be located next to the players 412. In the upper left of the Game page 400, a Leave Table button 402 may be located, which may be used to revert to a Lobby Overview page 600. The Game page 400 may have a Dealer Chat area 416, which may log the dealer actions at the table. A Table Chat 418, which may be located in the lower right of the page, may be used by the players 412 for instant messaging with simultaneous and/or on-demand translation. A Table Info area 422 of the Game page 400 may provide information on a total amount of stakes in the game and name of the table. A Player Info area 404 may provide player-related information (for example, the name of the users 126, 136, a total amount of virtual currency the users 126, 136 have).

The News area 406 of the Game page 400 may be used to provide various news items related to the game. As the game is selected by the users 126, 136, the News area 406 may automatically offer information related to similar but less known games that the users 126, 136 might be interested in, or related to some regional variations of the game that has been selected as normally played in a geography distant from, or unrelated to, the geography of the users 126, 136. The above information may be provided in the form of links.

In further example embodiments, the News area 406 of the Game page 400 may be used by a calendar of the platform-independent international gaming framework to notify the users 126, 136 about scheduled games and/or newly created ventures the users 126, 136 may be interested in based on the user-related information. The users 126, 136 may be able to receive notifications about one or more games that the users 126, 136 may be interested for a single gaming venue or for a plurality of the gaming venues.

A Settings button 408 may be used to access user settings and modify the user settings.

A Help button 410 may be clicked to display information associated with the functionality of the system or rules of the game being played. In some example embodiments, the information available as online help by clicking the Help button 410 may be translated into the language of the users 126, 136, based on settings of the gaming venue or game.

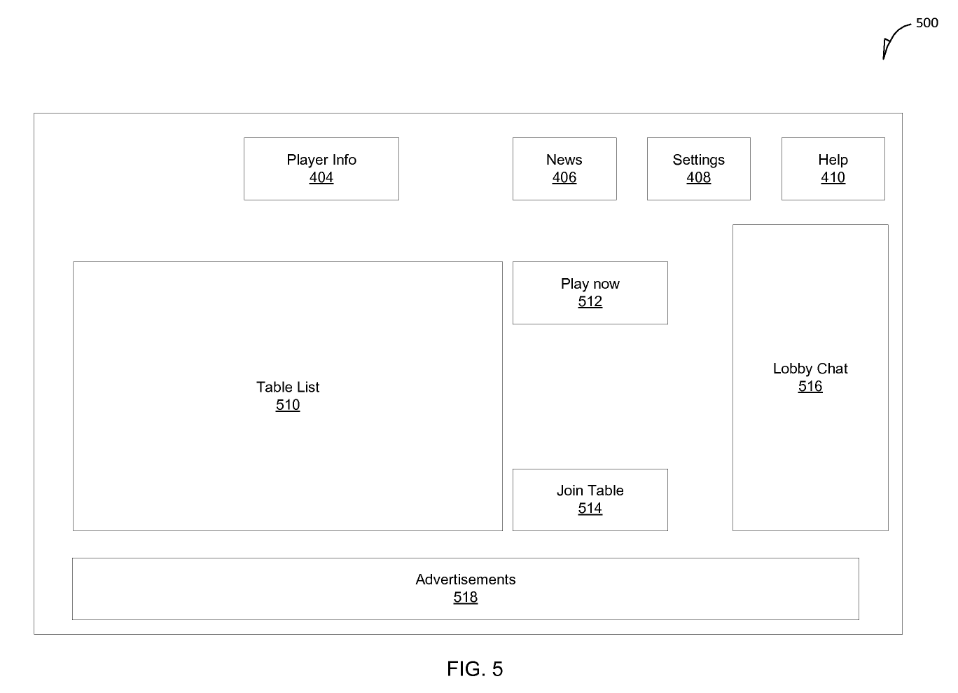

FIG. 5 discloses a tab 500 of the Game page 400, in accordance with one embodiment. A Table List area 510 of the page may display the names of the tables, a type of the game, and a level of the players 412, which, in some example embodiments, may be calculated based on a number of hands that have been won by the players 412 or based on an amount of virtual currency earned by the players 412. The information that may be displayed to the users 126, 136 may also include a buy-in for each of the tables, a status of the game, for example, “running” or “registering,” and a number of the players 412 taking part in the game (both possible number and actual number of the players may be shown). A Play now capability 512 may be used to join the table with a vacant seat. A specific table may be joined by the users 126, 136 by clicking a Join Table button 514. In some example embodiments, having entered a venue, the users 126, 136 may automatically be offered to take part in the one or more games based on the user- and/or user location-related information.

The tab 500 may include a Lobby Chat area 516 that may be used for instant messaging within the venue, and may include a simultaneous or on-demand translation.

An Advertisements area 518 at the bottom of the Game page 400 may be used for displaying promotional content. The promotional content may be displayed selectively depending on the geographical location of the users 126, 136, various demographics, personal information, the client device default language, and the default language of the users 126, 136 associated with the internal social network of the gaming framework or some other social network. In some example embodiments, a language of the promotional content may vary based on the said information as well.

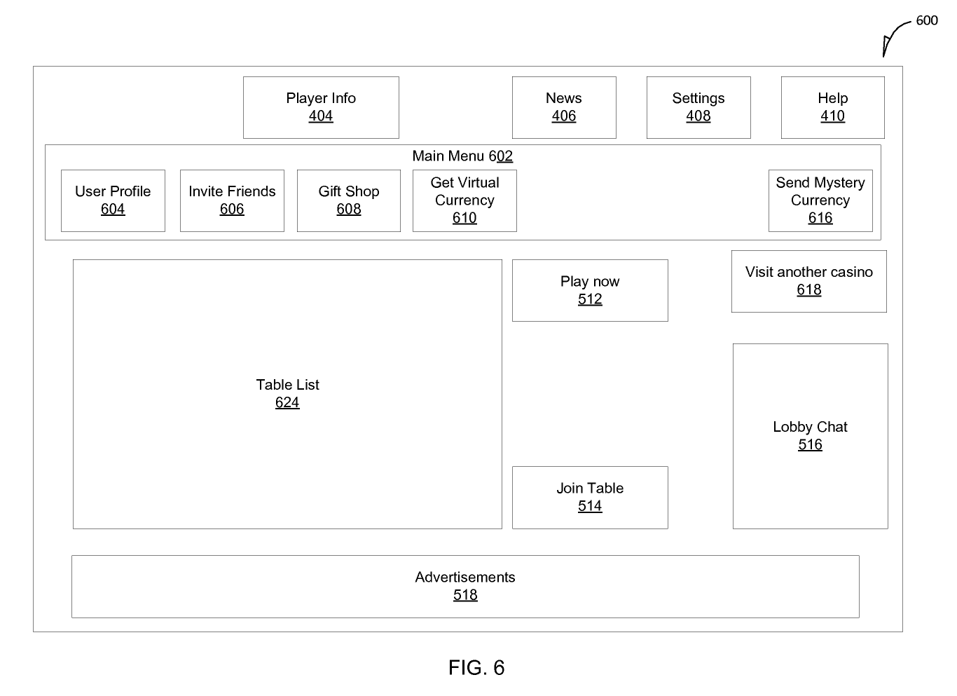

FIG. 6 is a Table List view 600 of the Lobby Overview page 600 and a Table List area 624 that may display information on the tables, game types, players, stakes, and maximum and minimum buy-ins. The Play now capability 512 may be used to join the table with a vacant seat. A specific table may be joined by the users 126, 136 by clicking a Join Table button 514. The users 126, 136 may display a list of other gaming venues by clicking a Visit another casino button 618. The users 126, 136 may be able to select from several virtual versions of popular gaming venues. The look and feel of the gaming framework, including the look and feel of the virtual goods, may vary accordingly. Furthermore, the users 126, 136 may also be invited to select from multiple local variations of the game that has been selected by the users 126, 136.

In some example embodiments, various gaming venues that the users 126, 136 are able to select may be styled after well-known gaming tournaments. For example, the users 126, 136 logging in from a location in Latin America may be invited to take part in a virtual version of the Latin American Poker Tour (LAPT), in which event the look and feel of the gaming framework, including the virtual goods involved, may be adjusted to emulate the environment and atmosphere of the tournament held in Brazil, Chile, Peru, Uruguay, or Colombia.

The Lobby Overview page 600 displays a main menu 602 that may provide such capabilities as Invite Friends 606 for inviting friends to a game of cards, Get Virtual Currency 610 for buying virtual currency, Gift Shop 608 for purchasing gifts, Get virtual currency 614 for receiving virtual currency, and Send Mystery Virtual Currency 616. Clicking a User Profile button 604 on the main menu 602 may display the profile of the users 126, 136 in the system.

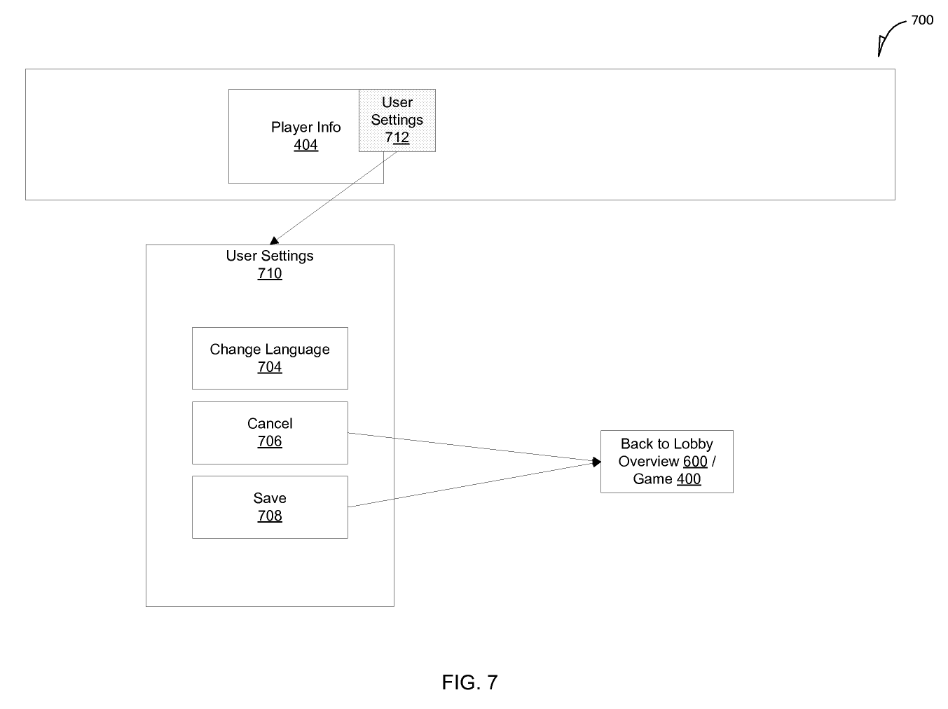

FIG. 7 illustrates a procedure 700 for accessing and working with a User Settings dialog box 710, in accordance with one example embodiment, which may allow defining such user settings as a user nickname, language, and country to be displayed to the other players. The User Settings dialog box 710 may be displayed by clicking a User Settings button 712. The User Settings dialog box 710 contains several capabilities/buttons. A Change Language button 704 may be clicked to change language. Modified user settings may be either saved by clicking a Save button 708, or cancelled by clicking a Cancel button 706. Both actions may take the users 126, 136 back to either the Game page 400 or to the Lobby Overview page 600, depending on from which of the two pages the User Settings dialog box 710 was accessed.

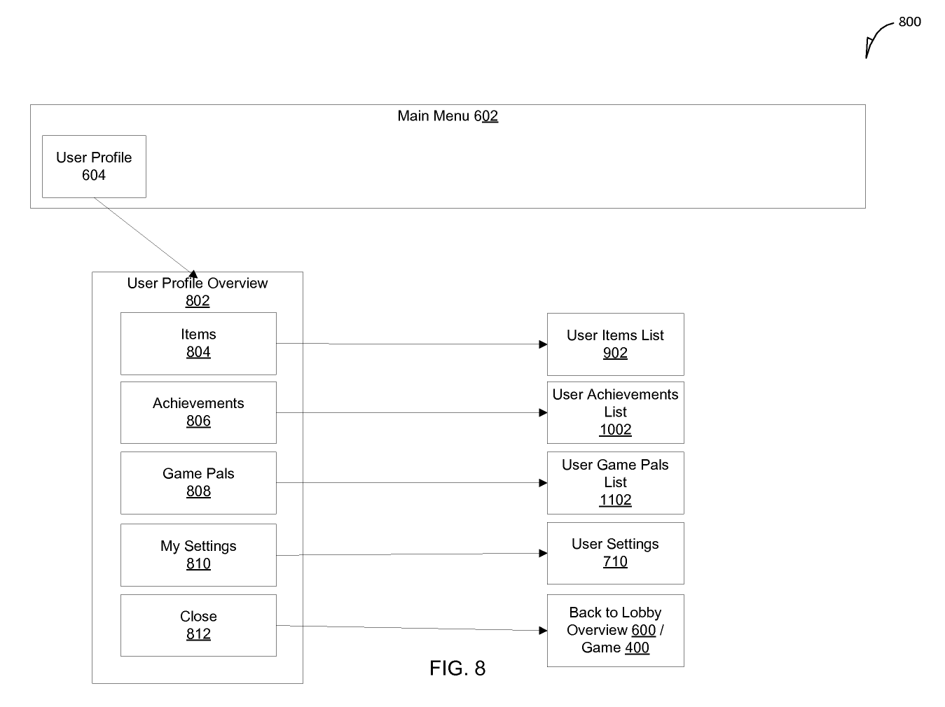

FIG. 8 illustrates a procedure 800 for accessing and working with the User Profile Overview page 802, in accordance with one example embodiment, which may be available by clicking the User profile button 604 on the main menu 602. The User Profile Overview page 802 may display a date on which the users 126, 136 started playing in the gaming framework or at a current venue, the number of hands that have been played by the users 126, 136, a number of hands that have been won by the users 126, 136, a number of sit & goes won by the users 126, 136, and highest chip level and highest pot won by the users 126, 136. In the same or other example embodiments, the User Profile Overview page 802 may be used by the users 126, 136 to publish various personal information and/or information associated with the gaming experience of the users 126, 136 associated with the gaming framework. The users 126, 136 may be able to indicate that the users 126, 136 want to find like-minded users 126, 136 looking to play the specific game variation.

The User Profile Overview page 802 may also have Items tab 804, Achievements tab 806, and Game Pals tab 808, as well as a My Settings button 810 and a Close button 812. Selecting the Items tab 804 may display a User Items List page 902 of the User Profile Overview page 802. Selecting the Achievements tab 806 may display a User Achievements List page 1002. The Game Pals tab 808 may be used to display a User Game Pals List page 1102. To display the User Settings dialog box 710, the users 126, 136 may click the My Settings button 810. The Close button 812 may be clicked to return to the Game page 400 or Lobby Overview page 600, depending on from which of the two pages the User Profile Overview page 802 was accessed.

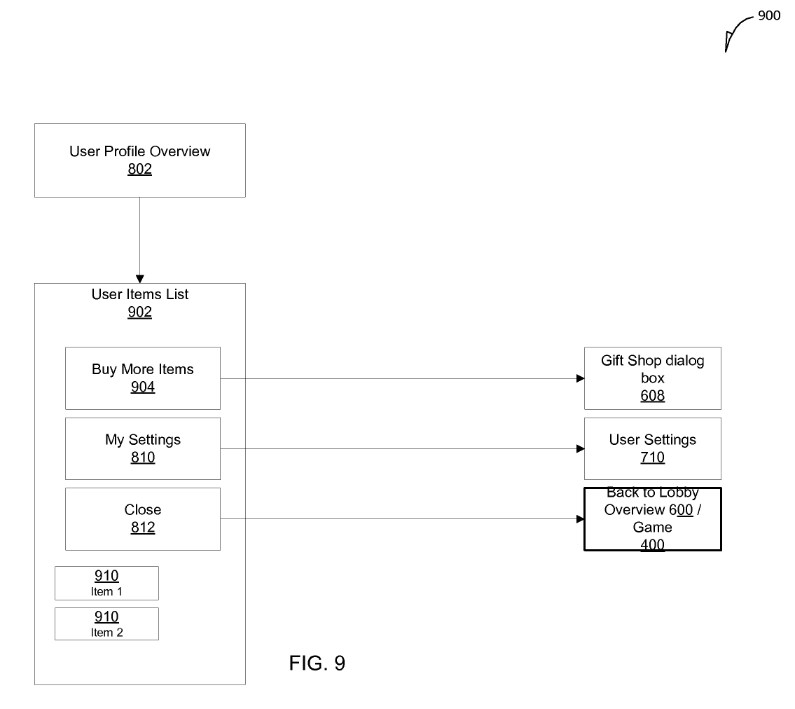

FIG. 9 illustrates a procedure 900 for accessing and working with the User Items List page 902 of the User Profile Overview page 802, in accordance with one example embodiment, which may display items 910 already purchased by the users 126, 136. By clicking Buy More Items 904 from the User Items List page 902, the users 126, 136 may access the Gift Shop dialog box 608. The users 126, 136 may also be able to access the User Settings dialog box 710 by clicking My Settings 810 button. The users 126, 136 may return to the Game page 400 or Lobby Overview page 600, depending on from which of the pages the User Profile Overview page 802 was accessed, by clicking Close 812.

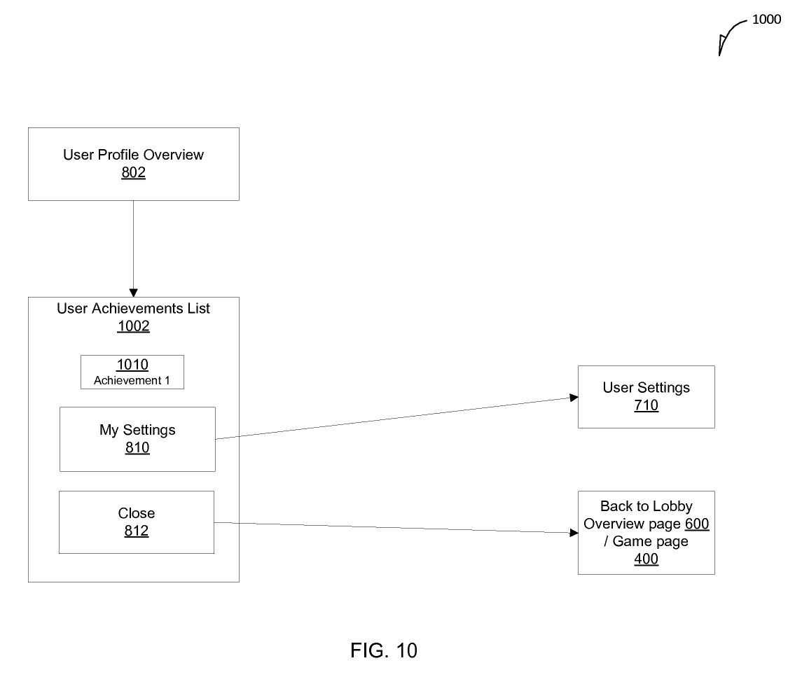

FIG. 10 illustrates a procedure 1000 for accessing and working with the User Achievements List page 1002 of the User Profile Overview page 802, in accordance with one example embodiment, which may display achievements 1010 of users 126, 136. By clicking the My Settings 810 button, the users 126, 136 may access the User Settings dialog box 710. To return to the Game page 400 or Lobby Overview 600 page, depending on from which of the pages the User Profile Overview page 802 was accessed, the users 126, 136 may need to click Close 812.

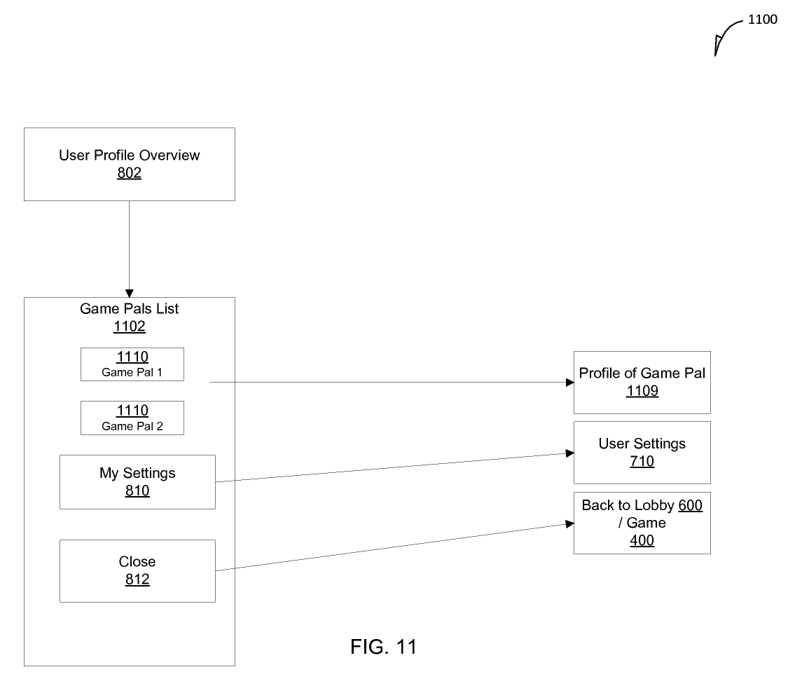

FIG. 11 illustrates a procedure 1100 of accessing and working with the Game Pals List page 1102 of the of the User Profile Overview page 802, in accordance with one example embodiment, which may display the icons of profiles of the game pals 1110 of the user, and also indicate the name of the game pals 1110 and amount of money that each of the game pals 1110 has. By clicking the icon of the profile of the game pal 1110, the users 126, 136 may display the Profile of Game Pal page 1109, which provides detailed information on the game pal 1110. By clicking the My Settings 810 button, the users 126, 136 may access the User Settings dialog box 710. To return to the Game page 400 or Lobby Overview page 600, depending on from which of the pages the User Profile Overview page 802 was accessed, the users 126, 136 may need to click Close 812.

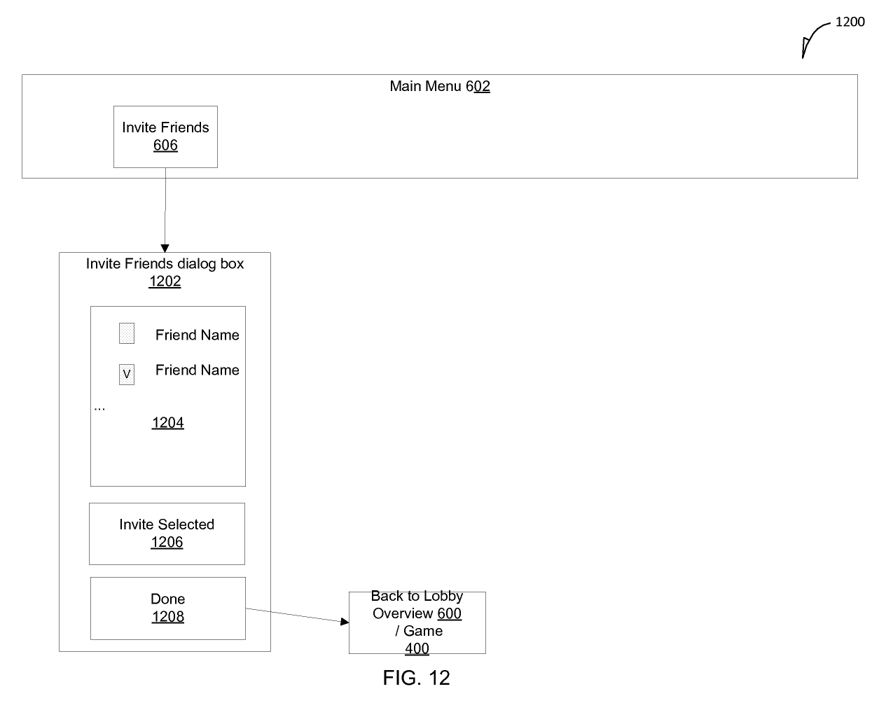

FIG. 12 illustrates a procedure 1200 of accessing and working with the Invite Friends dialog box 1202, in accordance with one example embodiment, which may allow adding the one or more friends of the users 126, 136 to a specific game. The Invite Friends dialog box 1202 may be available by clicking the Invite Friends button 606 on the Game page 400 or Lobby Overview page 600.

The users 126, 136 may select the one or more friends 1204 from a list of the friends of the users 126, 136 shown in the main area of the page by selecting one or more check boxes next to the one or more names of the friends. Next, the users 126, 136 may click Invite Selected 1206. To complete the procedure and return to the Game page 400 or Lobby Overview 600 page, depending on from which of the pages the Invite Friends dialog box 1202 was accessed, the users 126, 136 may need to click Done 1208.

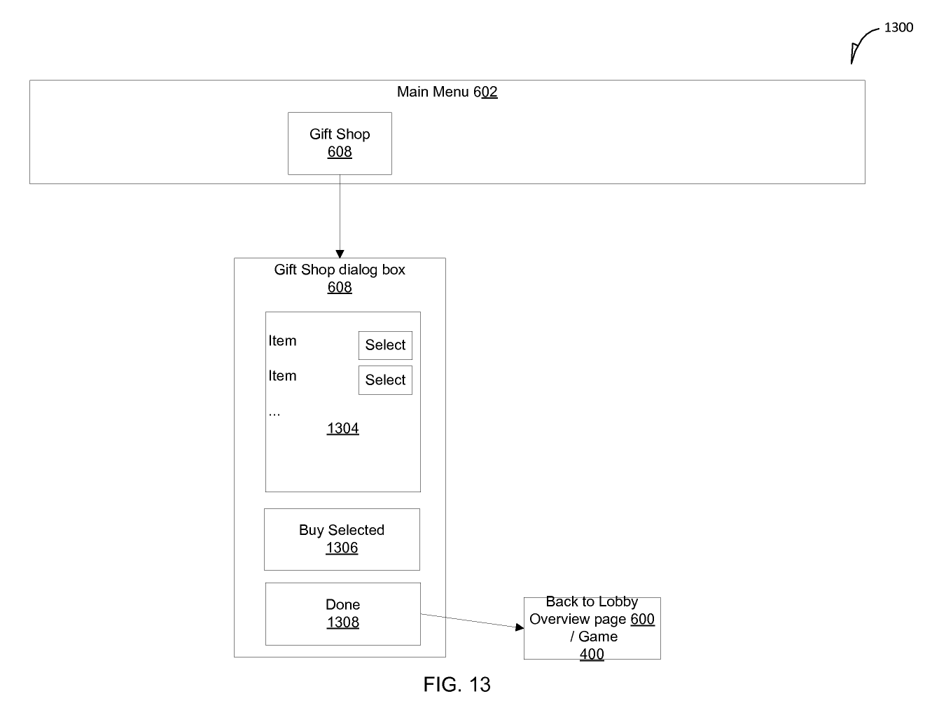

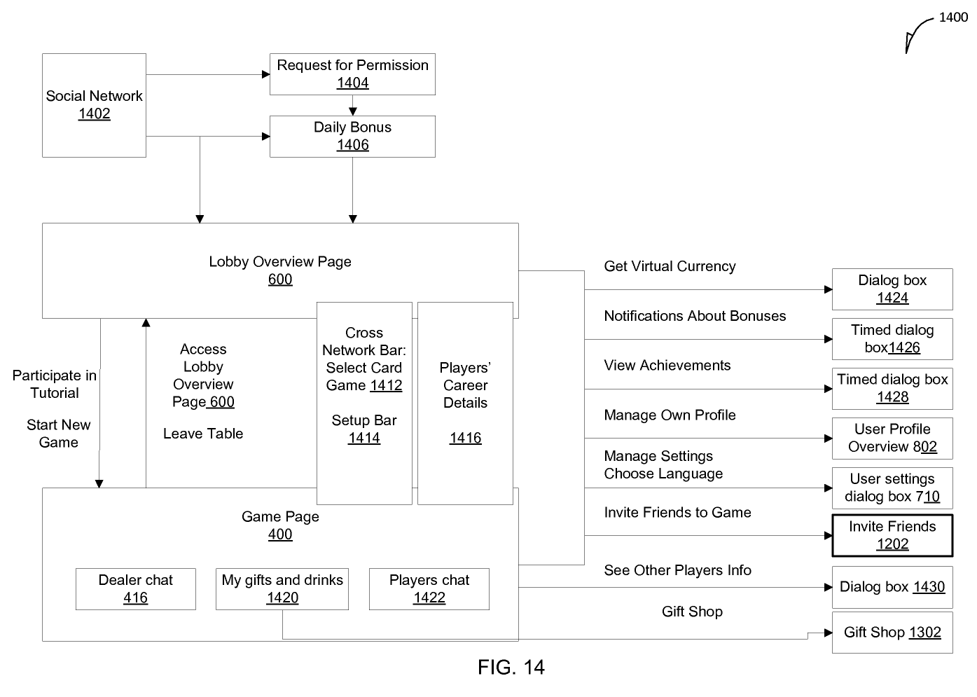

FIG. 13 illustrates a procedure 1300 of accessing and working with the Gift Shop dialog box 608, in accordance with one example embodiment, which may be available by clicking Gift Shop 608 on the Game page 400 or Lobby Overview page 600. The users 126, 136 may select the one or more items 1304 in the main area of the Gift Shop dialog box 608, and then click Buy Selected 1306 to purchase the one or more selected items 1304. To complete the procedure and return to the Game 400 page or Lobby Overview 600 page, depending on from which of the pages the Invite Friends dialog box 1202 was accessed, the users 126, 136 may need to click Done 1308. FIG. 14 is a process flow diagram providing a general overview 1400 of interaction between the social network 1402 (incidentally, Facebook) and the different components of the platform-independent international gaming framework, in accordance with one example embodiment. A social network user 126, 136 who signs up with the gaming framework may need to obtain permission 1404 to join the system. When the permission 1404 is granted, the above social network user 126, 136 may be taken to the Lobby Overview page 600.

The social network user 126, 136 who is already registered with the gaming framework may be taken to the Lobby Overview page 600 at once.

In some example embodiments, a social network user 126, 136 who is registered with the gaming network may be entitled to a daily bonus 1406.

From the Lobby Overview page 600, the users 126, 136 may select a table, or proceed to the Game page 400 to start a new game or to participate in a tutorial. On the Game page 400, a Dealer Chat area 416, a My Gifts and Drinks 1420 button, and a Players Chat area 1422 may be available. In some example embodiments, the Dealer Chat area 416 and the Players Chat 1422 may incorporate translation of instant messaging (the communications between the users 126, 136) in real time, while in other embodiements, the users 126, 136 may have to highlight the text that needs to be translated and click a button. Clicking the My Gifts and Drinks button 1420 may display the Gift Shop 1302.

From both Game page 400 and Lobby Overview page 600, the users 126, 136 may access information associated with other players (Players' Career Details 1416), which may be displayed in a Dialog box 1430.

The Setup Bar 1414 displayed on both Lobby Overview page 600 and Game page 400 may provide functionality for getting virtual currency may be displayed in a Dialog box 1424), receiving notifications about bonuses (may be displayed in a Timed dialog box 1426), calculating achievements (may be displayed in the User Achievements List page 1002, or a Timed dialog box 1428 for a certain period of time), viewing notifications about the bonuses (may be displayed in a Timed dialog box 1428), managing the user profile (may be displayed on the User Profile Overview page 802), managing the settings for a selected game (may be displayed in the User Settings dialog box 710), choosing a language (displayed in a dialog box in the User Settings dialog box 710), inviting the one or more friends to the specific game of cards (may be displayed in the Invite friends dialog box 1202). Both the Lobby Overview page 600 and Game page 400 display a Cross Network Bar 1412.

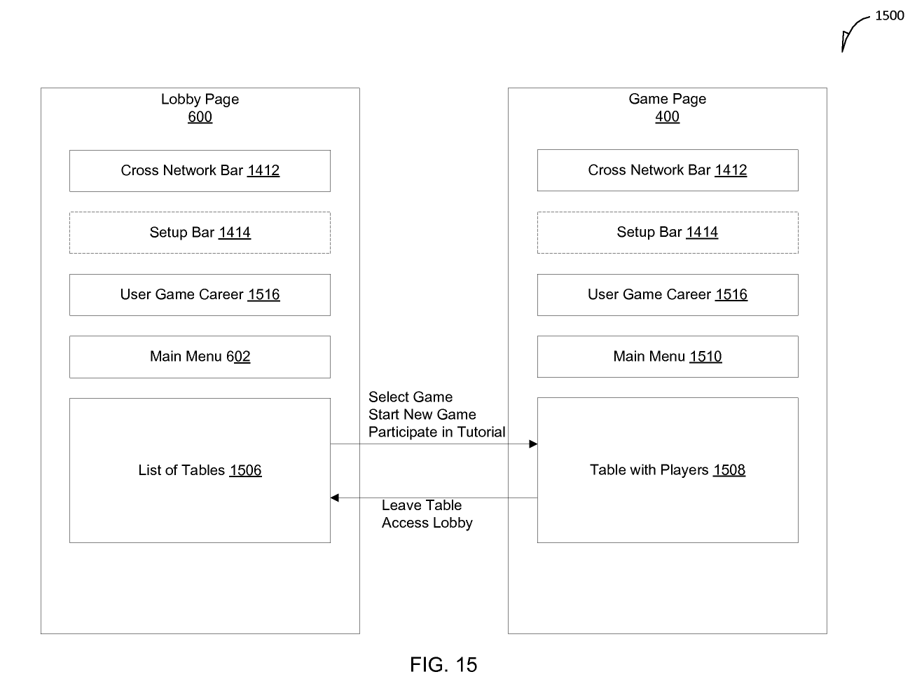

FIG. 15 is a block diagram, providing an overview of functionality 1500 provided by the Lobby Overview page 600 and Game page 400 of the application, in accordance with one example embodiment. The Lobby Overview page 600 may comprise the Cross Network bar 1412, the Setup Bar 1414, a User Game Career area 1516, the main menu 602, a List of Tables 1506 (the name of the area may vary in the present and other example embodiments depending on the tab of the Game page 400 that is currently selected).

The Game page 400 may comprise the Cross Network bar 1412, the Setup Bar 1414, a User Game Career area 1516, the List of Tables 1506 (the name of the area may vary in the present and other example embodiments depending on the tab of the Game page 400 that is currently selected), the Table with players area 1508, the Game Menu area 1510. The latter may provide a list of the game pals 1110 of the users 126, 136 taking part in the game and the name of a leader and runner-up in the game.

When a table is selected in the List of Tables area 1506 of the Lobby Overview page 600, the Game page 400 may be displayed with the Table with players area 1508 included. When a user 126, 136 leaves the table on the Game page 400, he may be taken back to the Lobby Overview page 600.

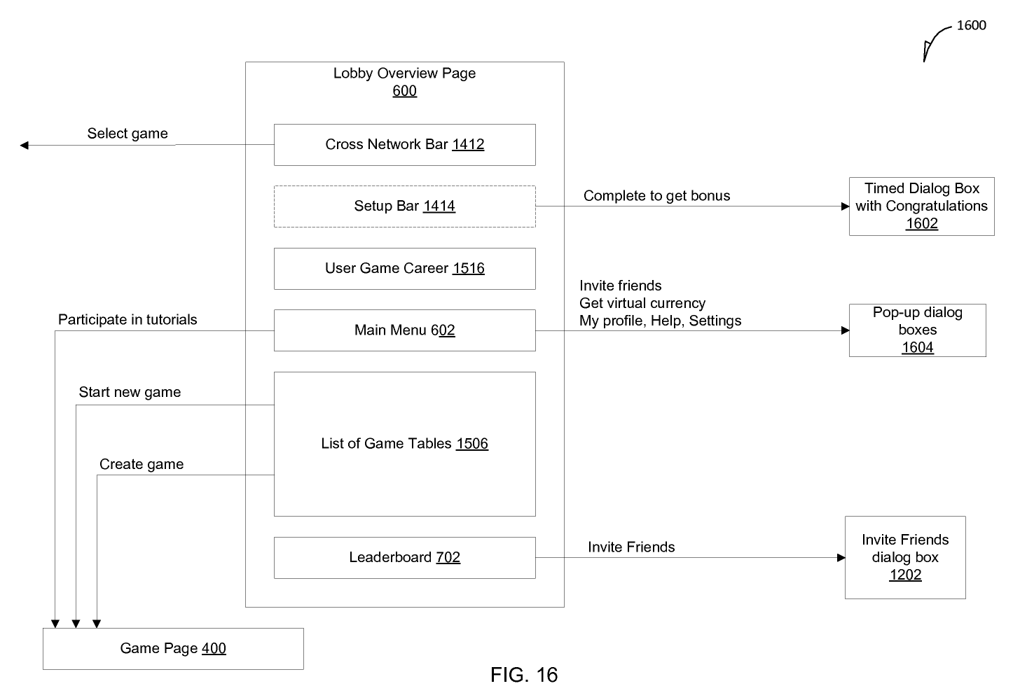

FIG. 16 discloses an overview of interactions 1600 between the Lobby Overview page 600 and other parts of the functionality of the gaming framework, in accordance with one embodiment. It may be possible to select the card game from a Cross Network bar 1412 on the Lobby Overview page 600. The Setup bar 1414 on the Lobby Overview page 600 may be used to enter information based on which user achievements may be calculated and displayed in a Timed Dialog Box with Congratulations 1602.

The main menu 602 on the Lobby Overview page 600 may be used to display a plurality of dialog boxes 1604, each of which may be used for a specific purpose, including inviting friends, earning virtual currency, and redefining the user settings. It may also be possible to access the User profile page. The users 126, 136 may be able to take part in a tutorial by accessing this functionality from the main menu 602. In the latter case, the Game page 400 may be displayed.

From the List of Tables area 1506 on the Lobby Overview page 600, it may be possible to access functionality for taking part in a new game or creating a new game. Both actions may display the said functionality on the Game page 400.

The Leaderboard area 702 on the Lobby Overview page 600 may be used to display a dialog box that allows inviting friends of the users 126, 136 to a specific game of cards. This may be done by displaying the Invite Friends dialog box 1202.

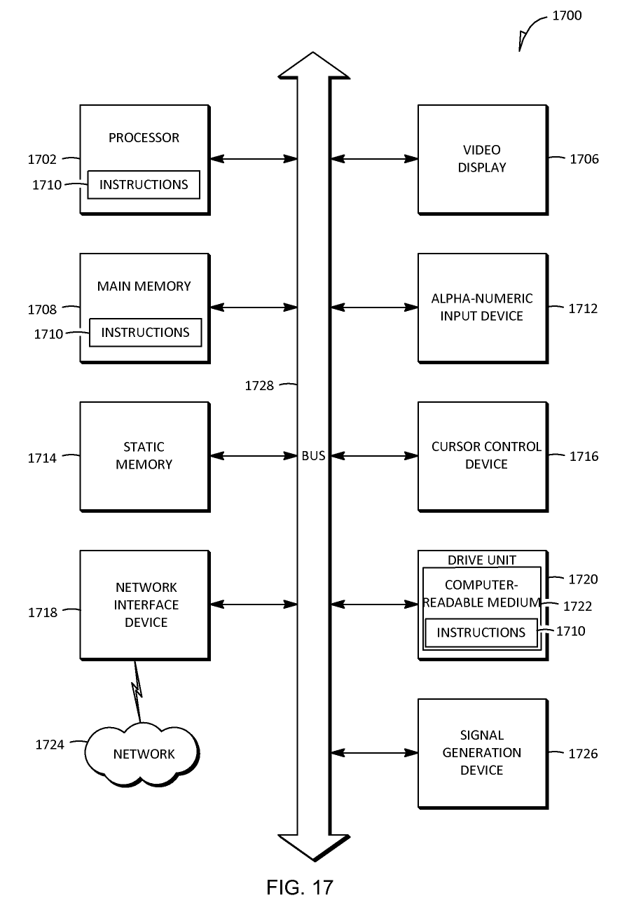

FIG. 17 shows a diagrammatic representation of a machine in the example form of a computer system 1700, within which a set of instructions for causing the machine to perform any one or more of the methodologies discussed herein may be executed. In various example embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an MP3 player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes one or more processors 1702 (e.g., a central processing unit (CPU), a graphics processing unit (GPU) or both), a main memory 1708, and a static memory 1714, which communicate with each other via a bus 1728. The computer system 1700 may further include a video display unit 1706. The video display unit 1706 may include a liquid crystal display (LCD) or any bistable display technology. The computer system 1700 also includes an alpha-numeric input device 1712 (e.g., a keyboard), a cursor control device 1716 (e.g., a mouse), a drive unit 1720, a signal generation device 1726 (e.g., a speaker), and a network interface device 1718.

The drive unit 1720 includes a machine-readable medium 1722 on which is stored one or more sets of instructions and data structures (e.g., instructions 1710) embodying or utilized by any one or more of the methodologies or functions described herein. The instructions 1710 may also reside, completely or at least partially, within the main memory 1704 and/or within the processors 1702 during execution thereof by the computer system 1700. The main memory 1708 and the processors 1702 also constitute machine-readable media.

The instructions 1710 may further be transmitted or received over a network 1724 via the network interface device 1718 utilizing any one of a number of well-known transfer protocols (e.g., Hyper Text Transfer Protocol (HTTP)).

While the machine-readable medium 1722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAM), read only memory (ROM), and the like.

The example embodiments described herein may be implemented in an operating environment comprising software installed on a machine, in hardware, or in a combination of software and hardware. Thus, a platform-independent international gaming framework and a cross-language communication tool have been described. Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

What is claimed is:

1. A computer-implemented method for providing a platform-independent international gaming framework, the method comprising:
localizing a game experience of a user within a multiplayer game environment with a plurality of international users, the localizing based on predetermined localization criteria associated with the user; and
translating communications between the plurality of international users.

2. The computer-implemented method of claim 1, wherein the predetermined localization criteria include one or more of the following: a geographical location, demographics, personal information, a client device language, a selected virtual gaming venue, and a social network profile language.

3. The computer-implemented method of claim 2, wherein the localization includes automatically or on click by a user loading one or more specific elements of a multiplayer game based on the predetermined localization criteria.

4. The computer-implemented method of claim 3, further comprising enabling the user to change a language associated with the multiplayer game.

5. The computer-implemented method of claim 1, further comprising providing, via a client device associated with the user, an interface for the platform-independent international gaming framework.

6. The computer-implemented method of claim 5, wherein the translation of communications occurs within a chat box associated with the interface.

7. The computer-implemented method of claim 5, further comprising enabling the user to toggle on and off an automatic translation.

8. The computer-implemented method of claim 5, wherein a source language of the translation is indicated.

9. The computer-implemented method of claim 1, wherein the client device is running one or more of the following operating systems: Windows, Unix, Mac OS, iOS, Android OS, Windows Phone, Symbian OS, Windows Mobile, Palm webOS, bada, MeeGo, Maemo, Limo, and Brew OS.

10. The computer-implemented method of claim 1, wherein the translating communications between the plurality of international users selectively comprises translating a text in response to receiving a request for a translation.

11. A system for providing a platform-independent international gaming framework, the system comprising:
a localization module to localize, based on predetermined criteria associated with a user, a game experience of the user within a multiplayer game environment with a plurality of international users; and
a communication module to automatically translate communications of the plurality of users into a language associated with the user.

12. The system of claim 11, wherein the localization is based on one or more of the following localization criteria: a geographical location of a client device, demographics associated with the user, personal information associated with the user associated with the client device, and a language associated with the client device or a social network profile.

13. The system of claim 12, wherein the localization is further configured to automatically load one or more specific elements based on the localization criteria.

14. The system of claim 12, further comprising a customization module to enable the user to change the language.

15. The system of claim 12, further comprising an interface for the platform-independent international gaming framework.

16. The system of claim 12, further comprising a translation module to translate communications within a chat box associated with the interface.

17. The system of claim 12, wherein a customization module is further configured to enable the user to toggle on and off the automatic translation.

18. The system of claim 12, wherein a source language of the translation is indicated.

19. The system of claim 11, wherein a client device is running one or more of the following operating systems: Windows, Unix, Mac OS, iOS, Android OS, Windows Phone, Symbian OS, Windows Mobile, Palm webOS, bada, MeeGo, Maemo, Limo, and Brew OS.

20. A machine-readable medium comprising instructions, which when implemented by one or more processors, perform the following operations:
localize a game experience of a user within a multiplayer game environment with a plurality of international users based on predetermined user settings; and
translate communications of the plurality of users into a language associated with the user.
